(19) United States
(12) Patent Application Publication
(10) Pub. No.: US 2023/0206711 A1
(43) Pub. Date: Jun. 29, 2023

(54) DATA EXTRACTION FROM IDENTIFICATION BADGES

(71) Applicant: Hewlett-Packard Development Company, L.P., Spring, TX (US)

(72) Inventors: Endrigo Nadin Pinheiro, Spring, CO (US); Christopher Charles Mohrman, Spring, CO (US); Nicholas Ian Sutton, Spring, CO (US); Stephen Mark Hinton, Spring, CO (US)

(73) Assignee: Hewlett-Packard Development Company, L.P., Spring, TX (US)

(21) Appl. No.: 17/926,889

(22) PCT Filed: Jun. 2, 2020
(86) PCT No.: PCT/US2020/035669

§ 371 Date: Nov. 21, 2022

(51) Int. Cl. G07C 9/20; G07C 9/27; G07C 1/10

(52) U.S. Cl. CPC G07C 9/20; G07C 9/27; G07C 1/10

(57) ABSTRACT

Example implementations relate to data extraction from identification badges. For example, a device that includes a processor and a memory resource storing instructions that when executed by the processor cause the processor to: identify a presence of a user within an area, identify that the user is wearing an identification badge, extract data from the identification badge, and add the extracted data to a database associated with attendance within the area.

### BACKGROUND

Physical areas can utilize different computing systems to perform different functions for users within the physical area. For example, a teleconference computing system can be positioned within a conference room. In this example, the teleconference computing system can provide teleconferencing for users within the area. In some examples, each user within the area may have to display credentials in order to enter the area and/or the user may have to log into the computing system after entering the area.

### BRIEF DESCRIPTION OF THE DRAWINGS

FIG. 1 illustrates an example system including a device for extracting data from identification badges consistent with the present disclosure.

FIG. 2 illustrates an example of a memory resource for extracting data from identification badges, in accordance with the present disclosure.

FIG. 3 illustrates an example system including a computing device for extracting data from identification badges, in accordance with the present disclosure.

FIG. 4 illustrates an example of identification badges that can be utilized for extracting data, in accordance with the present disclosure.

### DETAILED DESCRIPTION

In some examples, an attendance of users within an area can be tracked to identify a plurality of users that are within the area over a period of time. For example, a meeting for a plurality of users can be performed within a particular area. In this example, the attendance of the plurality of users can be monitored when the plurality of users registers with a computing device within the area and/or registers with a computing device that is monitoring or executing the meeting. In these examples, each user may have to register individually with a particular interface associated with the computing device associated with the area.

In previous examples, the computing device associated with the area can receive data associated with the plurality of users through a user interface within the area. For example, previous systems can utilize an interface with a display screen and/or peripheral device to allow each of the plurality of users to enter their corresponding user information to register such that the computing device can monitor and/or determine users within the area. However, the computing device may not be able to monitor or identify users that do not register with the computing device or provide their user information to the computing device. Other systems and methods may allow a user to enter their user information at an interface that includes a scanning device to scan a code associated with an identification badge. However, these systems also rely on a user manually entering or scanning their user information through the interface. Thus, users can bypass the interface and attend a meeting or utilize an area without registering with the computing device. In addition, these types of systems may not utilize an exit scan, which can allow a user to exit the area without updating the attendance within the area.

The present disclosure relates to extracting data from identification badges. The present disclosure allows a user to wear an identification badge that can have data extracted from the badge through an imaging device within the area. In some examples, the user may not have to present the badge to a scanning device and/or place the identification badge within a particular area (e.g., scanning area, etc.) to ensure that the computing device associated with the area has registered the user with the computing device. Thus, a user can freely enter an area without having to interact with an interface to enter user information and/or freely exit the area without having to interact with the interface to remove or end registration with the computing device. In this way, the present disclosure can more accurately monitor the movements of a user within a particular area without additional user interaction.

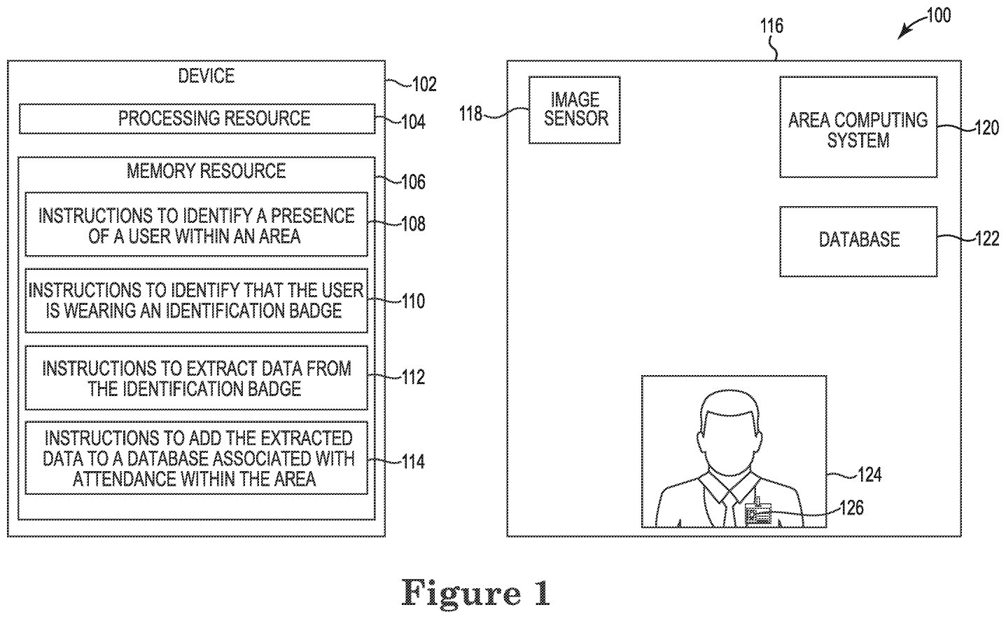

FIG. 1 illustrates an example system 100 including a device 102 for extracting data from identification badges 126 consistent with the present disclosure. In some examples the device 102 can be a computing device that includes a processing resource 104 communicatively coupled to a memory resource 106. As described further herein, the memory resource 106 can include instructions 108, 110, 112, 114 that can be executed by the processing resource 104 to perform particular functions. In some examples, the device 102 can be associated with an area 116. For example, the device 102 can be utilized to monitor users 124 within the area 116. In some examples, the device 102 can be local or remote to the area 116. For example, the device 102 can be a cloud resource that is remote from the area 116. In another example, the device 102 can be part of an area computing system 120 associated with the area 116.

In some examples, the system 100 can include an image sensor 118. In some examples, the image sensor 118 can include a camera or other type of device that can capture images. In some examples, the image sensor 118 can be utilized to identify human users, such as user 124, that are within the area 116. For example, the image sensor 118 can identify that an object within the area 116 is potentially a human user. In this example, the image sensor 118 can capture images of the potential human user. In this example, the images of the potential human user can be analyzed to determine if the potential human user is wearing an identification badge 126. As described further herein, the images of the potential human user can be analyzed utilizing a shape recognition application or other instructions to identify that the potential human user is wearing an identification badge 126. In these examples, the identification badge 126 within the image can be utilized to extract data associated with the potential human user 124 wearing the identification badge 126.

The device 102 can be a component of a computing device such as a processor, an application specific integrated circuit (ASIC), a field programmable gate array (FPGA), a metal-programmable cell array (MPCA), or other combination of circuitry and/or logic to orchestrate execution of instructions 108, 110, 112, 114. In other examples, the device 102 can be a computing device that can include instructions 108, 110, 112, 114 stored on a machine-readable medium (e.g., memory resource 106, non-transitory computer-readable medium, etc.) and executable by a processing resource 104.

In some examples, the device 102 can include instructions 108 that can be executed by a processing resource 104 to identify a presence of a user 124 within an area 116. In some examples the device 102 can identify the presence of the user 124 utilizing hardware associated with the area 116. For example, the device 102 can be communicatively coupled to an image sensor 118 within the area 116. In this example, the image sensor 118 can send a plurality of images to the device 102 and the device 102 can utilize the captured images to identify a human user such as the user 124. In other examples, the device 102 can be coupled to a door sensor that can detect when a user enters the door. In these examples, the device 102 can utilize the image sensor 118 to capture an image of a user utilizing the door and/or activating the door sensor. In these examples, the captured images can be utilized to determine when a human user has utilized the door and/or activated the door sensor.

In some examples, the device 102 can include instructions 110 that can be executed by a processing resource 104 to identify that the user 124 is wearing an identification badge 126. In some examples, the device 102 can utilize an image or a plurality of images of the user 124 to determine if the user is wearing an identification badge 126. For example, the image sensor 118 can capture an image of the user 124 and the device 102 can utilize a recognition application to identify that the user may be wearing an identification badge 126. As used herein, a recognition application can include instructions that can be stored in a memory resource 106 and executed by the processing resource 104 to recognize a particular feature of the identification badge 126.

In some examples, the recognition application can be utilized to identify particular shapes, colors, images, and/or other features that can correspond to a particular identification badge 126. For example, a particular identification badge 126 can utilize a particular shape and/or particular dimensions that can be utilized to identify the identification badge 126 from captured images from the image sensor 118. In this way, a user 124 may not have to present the identification badge 126 to a scanning device or to the image sensor 118. By automatically identifying the identification badge 126 on the user 124, the user 124 can be identified without relying on the user 124 to provide the identification badge 126 or credentials to the device 102. In some examples, this can also prevent a user 124 from intentionally avoiding a scanning device and/or avoiding registering with the device 102. That is, a user 124 attempting to avoid registering with the device 102 can still be identified when the user 124 is wearing the identification badge 126.

In some examples, the device 102 can identify an identification badge type when analyzing the captured image of the identification badge 126. In some examples, the device 102 can include instructions to identify the identification badge 126 as a particular type of identification badge based on a shape of the identification badge 126. For example, the device 102 can utilize the recognition application to identify the measurements of the borders and corresponding shape to identify the identification badge 126 as a particular type of identification badge. In other examples, the identification badge 126 can be identified as a particular type of identification badge based on a color of the identification badge 126.

As described herein, the type of identification badge can be utilized to identify a location of a plurality of data that can be extracted. For example, a first type of identification badge can include the name of a user in a first location and a second type of identification badge can include the name of the user in a second location.

In some examples, the device 102 can include instructions 112 that can be executed by a processing resource 104 to extract data from the identification badge 126. In some examples, extracting data from the identification badge 126 can include, but is not limited to: extracting images, extracting text, extracting color schemes, and/or other information that can be extracted from an image of the identification badge 126. In some examples, the identification badge can include a name or identification of the user 124. In these examples, the name or identification information of the user 124 can be extracted from an image of the identification badge 126 captured by the image sensor 118. As described herein, this data can be extracted from the identification badge 126 without knowledge or further action from the user 124. In this way, the data can be extracted from the identification badge 126 without relying on the user 124 to present the data or input the data. In this way, a more accurate human user attendance can be determined. For example, previous systems that do not automatically capture data from the identification badge 126 can be less accurate due to users 124 that forget to input their identification data and/or intentionally do not input their identification data.

In some examples, the device 102 can include instructions 114 that can be executed by a processing resource 104 to add the extracted data to a database 122 associated with attendance within the area 116. In some examples, the system 100 can include a database 122. The database 122 can be a memory resource that can be utilized to store data related to the area 116 and/or area computing system 120. Although the database 122 is illustrated as being within the area 116, the present disclosure is not so limited. For example, the database 122 can be a remote database and/or cloud resource that can be utilized to store data associated with the area 116 and/or the area computing system 120. In some examples, the database 122 can be a registration database associated with a teleconference application for a teleconference at the physical area 116. For example, the area computing system can be utilized to execute the teleconference application for performing a teleconference for users within the area 116.

In some examples, the data that is extracted from the identification badge 126 can include information related to an identity or user profile of the user 124. In these examples, the extracted data can be stored within the database 122 to mark an attendance of the user 124 within the area 116. In some examples, the area computing system 120 can be a system that is utilized by a group of users within the area 116. For example, the area computing system 120 can include a conferencing system for telecommunication. In this example, the extracted data from the identification badge 126 can be utilized to register with the area computing system 120 such that the device 102 adds the user 124 as an attendee with a particular conference of the area computing system 120.

In some examples, the device 102 can include instructions to log into a computing system 120 associated with the area 116 based on the extracted data from the identification badge 126. For example, the device 102 can extract a user name and/or credentials of the user 124 from the identification badge 126. In this example, the device 102 can utilize the extracted data to log into the area computing system 120 such that the user 124 can utilize the area computing system 120 without the user 124 having to provide identification information.

In some examples, the device 102 can be utilized to continuously monitor the attendance within the area 116 and/or continuously update the database 122 to reflect current attendees within the area 116 and/or current users of the area computing system 120. For example, the device 102 can utilize images from the image sensor 118 to determine a plurality of users 124 are within the area 116 at a particular time that can be based on a timestamp associated with the image utilized to determine the plurality of users 124 within the area 116 at a particular time. In this way, users 124 that leave the area 116 can be removed from a list of attendees or users of the area computing system 120. In that way, the device 102 can utilize the extracted data to track when the user 124 is within the area 116 and when the user 124 is outside the area 116. In addition, this can be performed without knowledge from the user 124 and/or relying on the user 124 to present or input their identification credentials (e.g., user data, ext.).

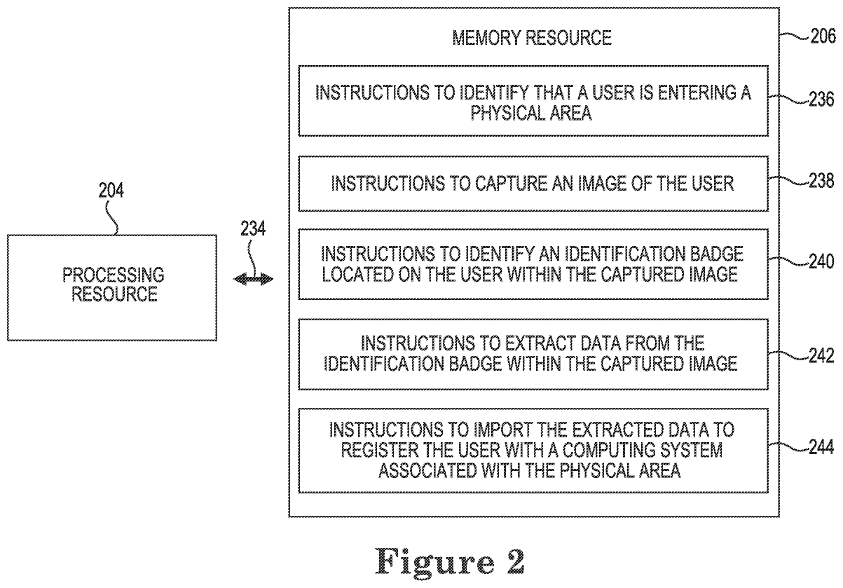

FIG. 2 illustrates an example of a memory resource 206 for extracting data from identification badges, in accordance with the present disclosure. In some examples, the memory resource 206 can be a part of a computing device or controller that can be communicatively coupled to a computing system within an area. For example, the memory resource 206 can be part of a device 102 as referenced in FIG. 1 and communicatively coupled to a computing system 120 as referenced in FIG. 1. In some examples, the memory resource 206 can be communicatively coupled to a processing resource 204 that can execute instructions 236, 238, 240, 242, 244 stored on the memory resource 206. For example, the memory resource 206 can be communicatively coupled to the memory resource 206 through a communication path 234. As used herein, a communication path 234 can include a wired or wireless connection that can allow communication between devices.

The memory resource 206 may be electronic, magnetic, optical, or other physical storage device that stores executable instructions. Thus, non-transitory machine readable medium (e.g., a memory resource 206) may be, for example, a non-transitory MRM comprising Random Access Memory (RAM), an Electrically-Erasable Programmable ROM (EEPROM), a storage drive, an optical disc, and the like. The non-transitory machine readable medium (e.g., a memory resource 206) may be disposed within a controller and/or computing device. In this example, the executable instructions 236, 238, 240, 242, 244 can be “installed” on the device. Additionally, and/or alternatively, the non-transitory machine readable medium (e.g., a memory resource 684) can be a portable, external or remote storage medium, for example, that allows the system 680 to download the instructions 236, 238, 240, 242, 244 from the portable/external/remote storage medium. In this situation, the executable instructions may be part of an “installation package”. As described herein, the non-transitory machine readable medium (e.g., a memory resource 206) can be encoded with executable instructions for data extraction from identification badges.

The instructions 236, when executed by a processing resource such as the processing resource 204, can include instructions to identify that a user is entering a physical area. As described herein, a user can be a human user that can enter or exit from a physical location, such as a room, office, cubicle, etc. In some examples, a human user can be identified when entering the physical area based on captured images of the user within the area. For example, the user can enter the physical area through an entrance (e.g., door, etc.). In this example, an image sensor can capture an image or plurality of images of the user and a recognition application can be utilized to confirm that the user entering through the entrance is a human user.

In some examples, the recognition application can include instructions that can be executed by a processing resource to determine if a human user is within the captured images. In some examples, the recognition application can be able to identify differences between human and non-human users (e.g., animals, robots, etc.).

The instructions 238, when executed by a processing resource such as the processing resource 204, can include instructions to capture an image of the user. As described herein, the recognition application can be utilized to identify that a human user has entered an entrance of the area. In some examples, an image of the user can be captured by an image sensor (e.g., image sensor 118, camera, video camera, etc.). In some examples, capturing an image of the user can include capturing a plurality of images of the user and utilize a particular image that includes particular features (e.g., face, identification badge, etc.).

The instructions 240, when executed by a processing resource such as the processing resource 204, can include instructions to identify an identification badge located on the user within the captured image. As described herein, the image can include particular features such as an identification badge that an identified user is wearing. As used herein, wearing an identification badge can include, but is not limited to: coupling an identification badge to clothing, skin, lanyards, or physical elements that allow a user to display the identification badge to others without holding the identification in their hands.

In some examples, a recognition application can be utilized to identify the identification badge based on features of the identification badge. In some examples, the features of the identification badge can include physical features (e.g., shape, color, etc.), printed features (e.g., symbols, text, etc.), and/or other features that can distinguish the identification badge from other elements that a user may be wearing (e.g., neck tie, bow tie, lapel pin, etc.). For example, the recognition application can identify a particular identification badge based on an outline or shape of the identification badge.

The instructions 242, when executed by a processing resource such as the processing resource 204, can include instructions to extract data from the identification badge within the captured image. As described herein, the captured images that are utilized to identify the identification badge can be utilized to also extract data from the identification badge. In some examples, the capture image can be a photograph of the identification badge. In these examples, the text, images, symbols, bar codes, etc. can be extracted from the capture image. In this way, the data from the identification badge can be extracted without the user knowing and/or having to provide the information or present the identification badge to a scanning device. In this way, the extracted data can be utilized to monitor attendance or presence within a physical area without relying on user interactions with a system.

The instructions 244, when executed by a processing resource such as the processing resource 204, can include instructions to import the extracted data to register the user with a computing system associated with the physical area. In some examples, the data extracted from the identification badge can correspond to user data and/or user profile data for a user wearing the identification badge. In some examples, this user data can be imported to register the user with the computing system associated with the physical area. As described herein, the computing system associated with the physical area can be a teleconference system and/or other type of attendance system to monitor the attendance within the physical area. In this way, the instructions 244 can update the computing system associated with the physical area on human users that are currently within the physical area.

In some examples, the memory resource 206 can include instructions to add the user to an attendee list associated with a meeting utilizing the computing system associated with the physical area. For example, a meeting of a plurality of human users can utilize an attendee list to identify users that attended the meeting and identify users that did not attend the meeting. In this example, the extracted information can be implemented into the attendee list and the attendee list can include a time period or quantity of time that a particular user was attending the meeting. In other examples, the extracted information can be utilized to identify when a user has entered the area and how long the user was within the area. In a specific example, the extracted information can be from a janitor. In this specific example, data from an identification badge of the janitor can be extracted and utilized to identify when the janitor entered the area to clean the area and how long the janitor was within the area performing the cleaning. In this way, the janitor's time can be monitored and utilized to determine how long each area takes to clean or how long an area is utilized by particular users.

In some examples, the memory resource 206 can include instructions to determine a quantity of time the user is within the physical area based on an entering time and an exiting time of the user. In some examples, the entering time can be based on a timestamp associated with the capture image and an exiting time can be based on a timestamp associated with a different captured image. For example, a first captured image can include a user entering the physical area. The first captured image can be utilized to extract data from the identification badge of the user and utilize the time stamp of the first captured image as an entering time for the user. In this example, a second captured image can include the user exiting the physical area. The second captured image can be utilized to extract data from the identification badge of the user and utilize the time stamp of the second captured image as the exiting time.

In some examples, the extracted data from the identification badge can be input into a registration form associated with an attendance within the area and/or associated with an attendance or usage of the computing system associated with the physical area. In this way, the present attendance within the physical area can be monitored without additional human interaction, which can lead to mistakes or manipulation as described herein.

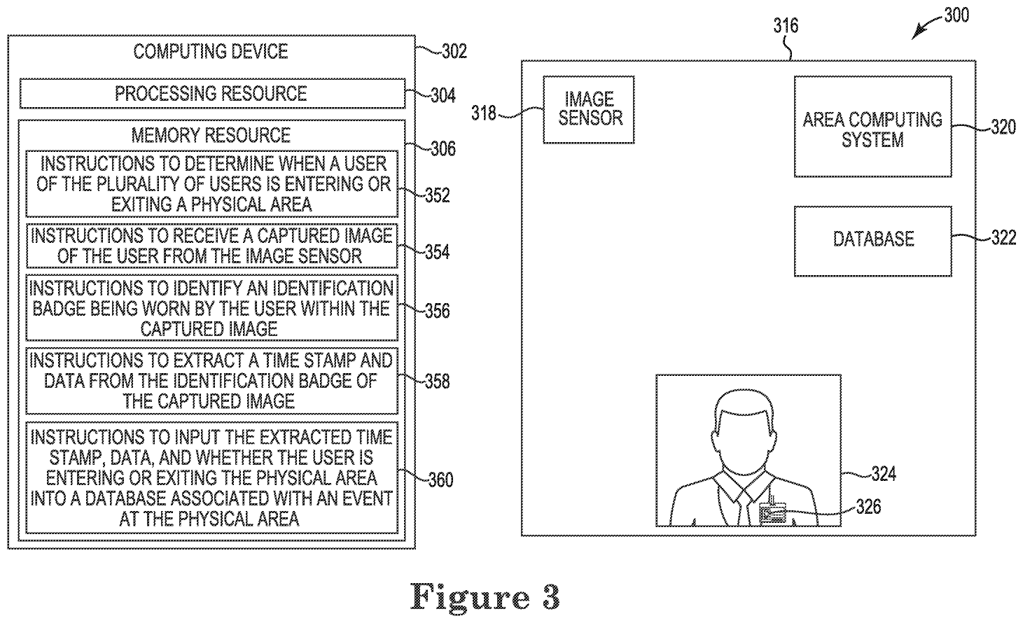

FIG. 3 illustrates an example system 300 including a computing device 302 for extracting data from identification badges 326, in accordance with the present disclosure. In some examples, the system 300 can include the same or similar elements as system 100 as referenced in FIG. 1. For example, the system 300 can include a physical area 316 that includes an image sensor 318, an area computing system 320 and/or a database 322. As described herein, the elements within the area 316 may be removed or remote from the area 316 without departing from the present disclosure.

The computing device 302 can include instructions 352, 354, 356, 358, 360 stored on a memory resource 106 (e.g., non-transitory computer-readable medium, etc.) and executable by a processing resource 304 to perform particular functions. In some examples, the computing device 302 can include instructions 352 that can be executed by a processing resource 304 to determine when a user 324 of the plurality of users is entering or exiting a physical area 316. As described herein, a number of hardware devices can be positioned within the area 316 to monitor when a potential human user enters or exits the physical area 316. In some examples, an image sensor 318 can be utilized to monitor when there is movement near an entrance of the area 316. For example, the image sensor 318 can capture images of the entrance when there is movement detected within the area of the entrance. In this example, images can be captured by the image sensor 318 in response to the detection of movement within the area of the entrance, which can indicate that a user 324 is either entering the area 316 or exiting the area 316.

In some examples, the computing device 302 can include instructions 354 that can be executed by a processing resource 304 to receive a captured image of the user from the image sensor 318. As described herein, the image sensor 318 can capture images of a human user and/or potential human user. In addition, the image sensor 318 can capture an image or images that include particular features. For example, the image sensor 318 can be communicatively coupled to the computing device 302 and transmit the captured images to the computing device 302 such that the computing device 302 can analyze the captured images. In some examples, the computing device 302 can utilize recognition applications to identify human users compared to non-human users.

In some examples, the computing device 302 can include instructions 356 that can be executed by a processing resource 304 to identify an identification badge being worn by the user within the captured image. As described herein, the computing device 302 can utilize recognition applications to identify that a human user is wearing an identification badge. As described herein, the recognition application can utilize physical features of the identification badge and/or images on the identification badge to identify that the user is wearing an identification badge. In some examples, the same image utilized to identify the human user can be utilized to identify that the human user is wearing the identification badge.

In some examples, the computing device 302 can include instructions 358 that can be executed by a processing resource 304 to extract a time stamp and data from the identification badge 326 of the captured image. As described herein, the image sensor 318 can generate a time stamp to indicate when the image was captured by the image sensor 318. In these examples, the computing device 302 can extract the time stamp generated by the image sensor 318 and store the time stamp data with other extracted data from the image of the identification badge 326. As described herein, the extracted data from the identification badge 326 can include data related to the user 324 wearing the identification badge 326.

In some examples, particular data can be extracted from the identification badge 326 based on the area computing system 320 associated with the area 316. For example, the area computing system 320 can be utilized to monitor an attendance of a conference that is occurring within the area 316. In this example, the name of the user 324 may be utilized to identify that the user 324 entered or exited the room, which can correspond to their attendance within the area 316. In other examples, the area computing system 320 can be utilized to ensure that users 324 with a particular security clearance are allowed to attend a particular conference or meeting within the area 316. In these examples, the security clearance or security level of the user 324 can be extracted from the identification badge 326 and utilized to determine if the user 324 is allowed to attend the particular conference. In some examples, the area computing system 320 can start a meeting within the area 316 when the particular user (e.g., user 324, etc.) enters the area 316. In these examples, the meeting can be automatically started when all of the attendees or a particular portion of the attendees are identified.

In some examples, the computing device 302 can include instructions 360 that can be executed by a processing resource 304 to input the extracted time stamp, data, and whether the user is entering or exiting the physical area into a database 322 associated with an event at the physical area 316. As described herein, the extracted data from the identification badge 326 and/or the captured image into the database 322. In some examples, the data that is input into the database 322 can be based on the area computing system 320 as described herein. In some examples, the database 322 can be utilized by the area computing system 320 and/or the computing device 302 to log the attendance data associated with the area 316.

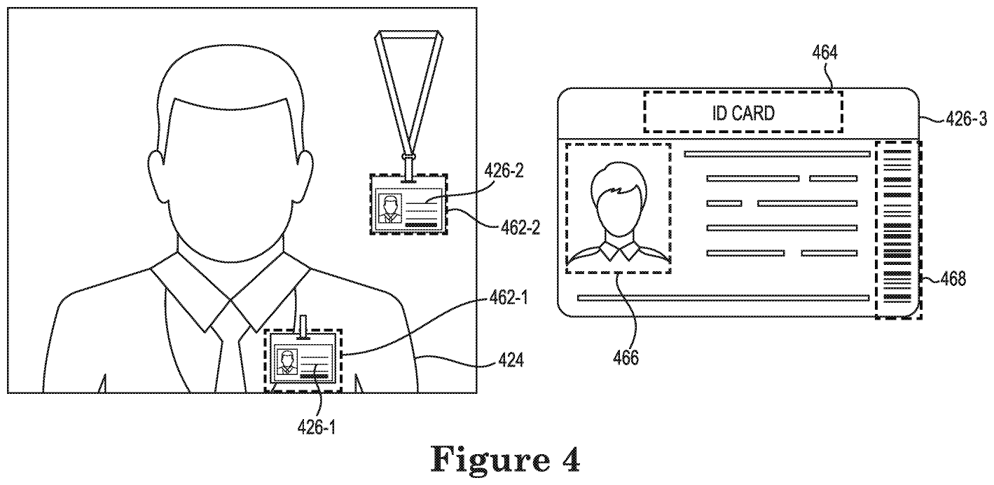

FIG. 4 illustrates an example of identification badges 426-1, 426-2, 426-3 that can be utilized for extracting data, in accordance with the present disclosure. In some examples, the identification badges 426-1, 426-2, 426-3 can be wearable identification badges. As described herein, a wearable identification badge is a badge that can be physically attached or coupled to a human user, such that the identification badges 426-1, 426-2, 426-3 can be displayable to other users without the user having to present the identification badges 426-1, 426-2, 426-3. In a specific example, the identification badge 426-1 can include a clasp that can be attached to a user's 424 clothing. In another specific example, the identification badge 426-2 can include a lanyard that can be worn around the neck of the user 424 to display the identification badge 426-2. In some examples, the identification badge 426-3 can be implemented into a device such as a clasp or lanyard to be worn by the user 424.

As described herein, a recognition application can be utilized to identify relevant data for a particular computing system and/or extract data from the identification badges 426-1, 426-2, 426-3. In some examples, the recognition application can utilize shape recognition to identify a shape of the identification badges 426-1, 426-2, 426-3. For example, the recognition application can identify a border 462-1, 462-2. In this example, the border 462-1, 462-2 can be a particular shape that is known or provided to a computing device. For example, the shape of the identification badges 426-1, 426-2, 426-3 can be rectangular, square, triangular, etc. In this example, the identification badges 426-1, 426-2, 426-3 can be identified while being worn by the user 424.

As illustrated by identification badge 426-3, a plurality of areas on the identification badge 426-3 can include particular information. This information can be displayed on the identification badge 426-3 at particular locations. The particular locations can be provided to a computing device (e.g., computing device 102 as referenced in FIG. 1, etc.) such that the computing device can more easily identify the data to be extracted. For example, the computing device can determine the data to be extracted is a name of the user 424. In this example, the computing device can utilize the location information to identify a proximate location of the name of the user 424. In other examples, the data to be extracted can be identified based on a shape, size, text, or other feature of the identification badge 426-3. For example, the computing device can identify a name border 464, an image border 466, and/or a barcode border 468, among other features or data associated with the identification badge 426-3.

In some examples, the computing device can identify a name associated with the user 424 based on text within an identified name border 464. In these examples, the computing device can determine if the name of the individual is to be utilized with a computing system associated with a particular area and/or if the name is to be utilized to register the user 424. If the name of the user 424 is to be utilized to register the user 424 with a computing system of a physical area, the computing device can utilize text extraction to extract the text associated within the name border 464. In this example, the computing device can utilize the extracted text data to register the user 424 with a computing system and/or register the user 424 as attending a particular event within the physical area.

In some examples, the computing device an identify an image associated with the identification badge 426-3 based on an image within the image border 466. In some examples, the image within the image border 466 can be compared to an image of the user 424 from the same captured image. For example, an image sensor can capture an image of the user 424 wearing the identification badge 426-3. In this example, the user's face 424 may be in the same captured image with the identification badge 426-3. In this example, the image within the image border 466 can be compared to the captured image of the user's 424 face. In these examples, the computing device can confirm that the user 424 is wearing the correct identification badge 426-3.

In some examples, the computing device can identify a barcode or encoded image (e.g., QR code, etc.) on the identification badge 426-3. In some examples, the computing device can identify a barcode border 468 that includes a barcode or other encoded image. As described herein, the computing device can extract a user profile and/or security level of the user 424. In some examples, the barcode within the barcode border 468 can be utilized to extract the user profile information for the user 424 and/or extract security level data for the user 424. In some examples, the additional data that is extracted can be utilized or implemented into a computing system associated with a particular physical area.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense. As used herein, the designator “N”, particularly with respect to reference numerals in the drawings, indicates that a number of the particular feature so designated can be included with examples of the present disclosure. It is also to be understood that the terminology used herein is for the purpose of describing particular examples only and is not intended to be limiting. As used herein, the singular forms “a,” “an,” and “the” can include both singular and plural referents, unless the context clearly dictates otherwise. The designators can represent the same or different numbers of the particular features. Further, as used herein, “a number of” an element and/or feature can refer to one or more of such elements and/or features.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed:

1. A device, comprising:
a processor; and
a memory resource storing instructions that when executed by the processor cause the processor to:
identify a presence of a user within an area;
identify that the user is wearing an identification badge;
extract data from the identification badge; and
add the extracted data to a database associated with attendance within the area.

2. The device of claim 1, wherein the identification badge is identified as a particular type of identification badge based on a shape of the identification badge.

3. The device of claim 1, wherein the identification badge is identified as a particular type of identification badge based on a color of the identification badge.

4. The device of claim 1, wherein the extracted data is utilized to register the user for an event within the area.

5. The device of claim 1, wherein the extracted data is utilized to track when the user is within the area and when the user is outside the area.

6. The device of claim 1, wherein the extracted data is utilized to verify a security level of the user.

7. The device of claim 1, wherein the memory resource stores instructions that when executed by the processor cause the processor to log into a computing system associated with the area based on the extracted data.

8. A non-transitory machine-readable storage medium comprising instructions executable by processing resource to:
identify that a user is entering a physical area;
capture an image of the user;
identify an identification badge located on the user within the captured image;
extract data from the identification badge within the captured image; and
import the extracted data to register the user with a computing system associated with the physical area.

9. The medium of claim 8, further comprising instructions executable to add the user to an attendee list associated with a meeting utilizing the computing system associated with the physical area.

10. The medium of claim 8, further comprising instructions executable to utilize the extracted data to log the user into the computing system associated with the physical area.

11. The medium of claim 8, further comprising instructions executable to determine a quantity of time the user is within the physical area based on an entering time and an exiting time of the user, wherein the entering time is based on a timestamp associated with the capture image.

12. The medium of claim 11, further comprising instructions executable to determine the exiting time of the user based on a captured image of the user exiting the physical area.

13. A system, comprising:
an image sensor to capture images of a plurality of users entering and exiting a physical area;
a computing device, comprising instructions to:
determine when a user of the plurality of users is entering or exiting a physical area;
receive a captured image of the user from the image sensor;
identify an identification badge being worn by the user within the captured image;
extract a time stamp and data from the identification badge of he captured image; and
input the extracted time stamp, data, and whether the user is entering or exiting the physical area into a database associated with an event at the physical area.

14. The system of claim 13, wherein the database is a registration database associated with a teleconference application for a teleconference at the physical area.

15. The system of claim 13, wherein the time stamp and data are extracted from the identification badge while the identification badge is worn by the user.
